(19) United States
(12) Patent Application Publication
(10) Pub. No.: US 2011/0314163 A1
(43) Pub. Date: Dec. 22, 2011

(54) WIRELESS COMMUNICATION NETWORK FOR SMART APPLIANCES

(75) Inventors: Mark Jeremy Borins, Toronto (CA); Daniel Jordan Moneta, Toronto (CA); Alireza Motamed, Toronto (CA); Eugene Yijun Peng, Toronto (CA); David Smith, Toronto (CA)

(73) Assignee: MMB RESEARCH INC., Toronto (CA)

(21) Appl. No.: 12/817,014

(22) Filed: Jun. 16, 2010

(51) Int. Cl. G06F 9/46; G06F 15/16

(52) U.S. Cl. 709/227; 718/102

(57) ABSTRACT

A communications module, and a consumer device comprising the communications model, is provided for use in a communication network with one or more consumer devices or “smart” appliances. The communications module includes a wireless transceiver for communication with the network, for example in accordance with the ZigBee protocol, and an interface for communicating with a host processor of the consumer device. The module receives scheduled event data over a wireless link on behalf of the host processor, and schedules events for execution by the host processor upon receipt of commands transmitted by the module. The communications module may include a virtual host module, which translates commands between a protocol used by the host processor and a protocol used by the communications module. The communications module is also configured to automatically seek and join a network, and to discover and bind to services provided over the network.

### BACKGROUND

1. Technical Field

The present application relates generally to the configuration and operation of a wireless data transmission network.

2. Description of the Related Art

Home automation and management of energy consumption by appliances, user devices and other home and industrial equipment is a field of increasing interest. Automation and control of devices in a household environment may be carried out using wireless protocols such as the ZigBee® wireless specification. However, the complexity of implementing ZigBee and other similar protocols, together with the inherent costs of equipping household appliances and devices to be compliant with these protocols, presents an obstacle to widespread adoption of these technologies as well as to retrofitting of existing consumer devices to become smart energy-compliant.

### BRIEF DESCRIPTION OF THE DRAWINGS

In drawings which illustrate by way of example only embodiments of the present application,

FIG. 1 is a block diagram of a single private home area network comprising an energy service portal and a number of devices.

FIG. 2 is a block diagram of a single device in communication with an energy service portal.

FIG. 3 is a schematic diagram of a protocol stack implemented in the device of FIG. 2.

FIG. 4 is a state diagram for a device in the home area network of FIG. 1.

FIG. 5 is a schematic diagram illustrating service discovery communications between a device and energy service portal.

FIG. 6 is a schematic diagram illustrating binding communications between a device and energy service portal.

FIG. 7 is a schematic diagram illustrating key establishment communications between a device and energy service portal.

FIGS. 8 to 10 are block diagrams of communication flow between an energy service portal and a network device.

FIGS. 11 and 12 are block diagrams of a communications module in a device in communication with a host processor.

FIG. 13 is a block diagram of a frame for use in communication between a communications module and a host processor.

### DETAILED DESCRIPTION

The embodiments described herein provide an improved communication network comprising one or more smart appliances as well as other devices, as well as methods of establishing and managing the network. Although the embodiments described below are set out with reference to a home area network such as may operate in a residential location, with appliances, heating and cooling systems, and controllers for use with particular types of commodities supplied by utilities—i.e., natural gas, electricity, water, and so forth—it will be appreciated that these are provided as non-limiting examples, and that the embodiments described herein, their systems and methods, are also applicable to other devices, utilities, commodities, appliances, and both home and industrial locations.

Thus, in accordance with the embodiments described herein, there is provided a communications module for use in a consumer device, the communications module comprising a wireless transceiver adapted to communicate over a wireless link; an interface for communicating with a host processor of the consumer device; and a processor in communication with the memory, the wireless transceiver, and the interface, in which the processor is configured to receive scheduled event data over the wireless link on behalf of the host processor; schedule events for the host processor using the scheduled event data thus received; and transmit commands for said scheduled events to the host processor for execution. There is also provided a consumer device with a host processor and the communications module.

In an aspect of these embodiments, the scheduled event data may comprise Smart Energy profile data, such as Demand Response and Load Control events; Price events; and Messaging events. Further, the wireless communication may be carried out in accordance with the ZigBee® specification. In still a further aspect, the processor may receive the scheduled event data by synchronizing a data store in the communications module with data stored at a service portal over the wireless link, and may schedule events by caching the received schedule event data until an execution time associated with said received schedule event data, and generating a scheduled event message for the host processor for transmission to the host processor at the execution time.

In a further aspect, commands may be transmitted to the host processor in a format comprising at least one frame, the frame comprising a header and a payload, the header comprising a primary header field and a secondary header field, a primary header field value defining a first frame type and a secondary header field value defining a subtype of the first frame type, and the payload comprising data for said scheduled event. In a still further aspect, the processor of the communications module may scan for and join the communications module to a wireless network; and upon joining the wireless network, bind to at least one service provided by a services portal on the wireless network, wherein binding comprises identifying a service endpoint for said at least one service and transmitting binding information for the communications module to the services portal for storage at the services portal.

In another aspect, the communications module may include a virtual host module in communication with the interface and with the wireless transceiver, wherein the communications module is configured to exchange the scheduled event data with the host processor over the interface according to a first protocol associated with the host processor and to exchange the scheduled event data over the wireless link according to a second protocol associated with an application layer of the communications module, and the virtual host module is configured to translate the scheduled event data between the first protocol and the second protocol. The scheduled event data may be provided to the virtual host module in at least one frame, the frame comprising a header and a payload, the header comprising a primary header field and a secondary header field, a primary header field value defining a first frame type and a secondary header field value defining a subtype of the first frame type, and the payload comprising data for said scheduled event.

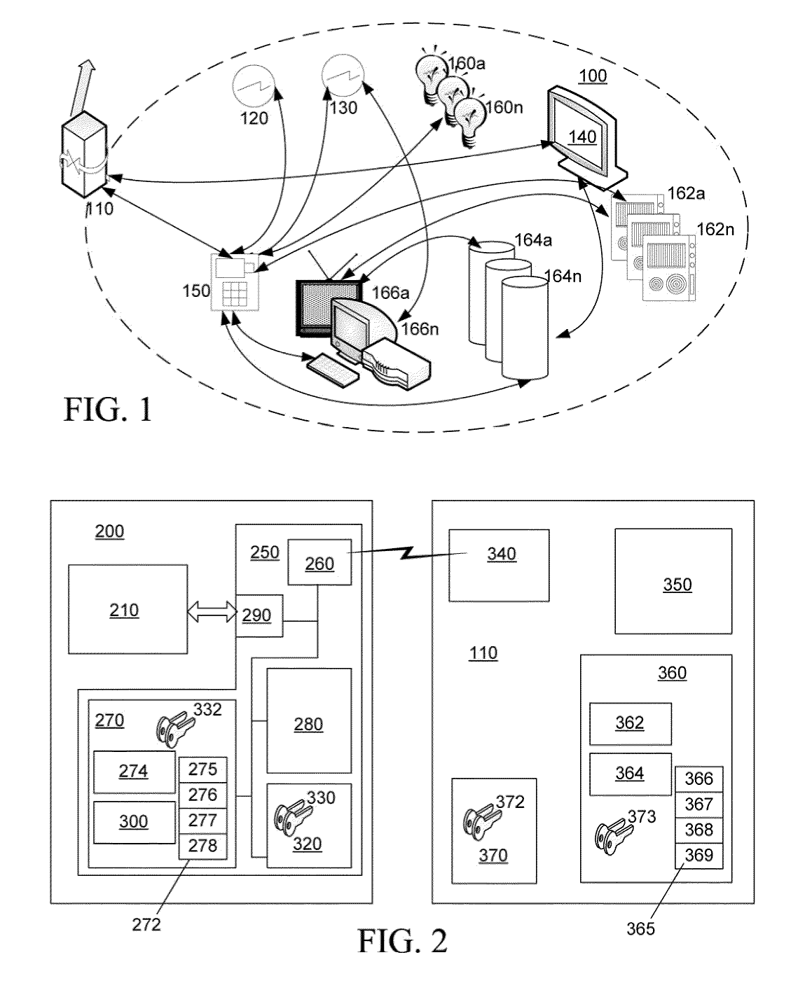

Turning to FIG. 1, an exemplary network topology for a home area network (HAN) 100 for control and management of smart energy devices is shown. An energy service portal (ESP) 110 is provided, which may comprise a separate gateway device or be comprised in a smart meter for measuring the consumption of a commodity or utility product (e.g. water, electricity, gas, or other consumables typically delivered by utility companies). The ESP 110 communicates with devices outside the HAN 100, such as an advanced metering initiative server that receives reports from the ESP 110 and forwards them over a network to a utility supplying the product, and forwards messages addressed to the ESP 110 received from the utility to the ESP 110. Thus, in the embodiment depicted in FIG. 1, the ESP 110 operates in part as a gateway device. The ESP 110 is provided with a communication link to one or more devices, such as smart meters 120, 130, an in-home display 140, a home energy management console 150, and smart appliances 160a . . . n, 162a . . . n, 164a . . . n, and 166a . . . n. Customer usage and pricing data may be transmitted between the ESP 110 and each of the in-home display 140 and home energy management console 150, and control messages and other data between the home energy management console 150 and each of the smart appliances 160a . . . n. Each of the smart appliances 160a . . . n, 162a . . . n, 164a . . . n, and 166a . . . n may be defined within the HAN 100 as a particular device type; for example, appliances 160a . . . n may comprise lighting fixtures; appliances 162a . . . n may comprise major household appliances, such as refrigerators; appliances 164a . . . n may comprising heating and cooling appliances such as HVAC units; and appliances 166a . . . n may comprise other devices, such as entertainment and personal devices (televisions, personal computers, and the like). Each of the individual devices 160a . . . n through 166a . . . n may comprise an individual node in the network 100, each comprising its own radio module for communicating with the ESP 110 and/or other devices on the network; alternatively, multiple devices may be comprised in a single node, and may communicate with the other devices on the network through a shared radio module.

While communication among the various elements of the HAN 100 may be effected over fixed (wired) links, wireless communication links may be established among the devices, thus affording a measure of flexibility in the physical arrangement of devices in the HAN 100. Individual devices, including the ESP 110 and the other devices 120 through 166a . . . n may therefore be equipped with a module comprising an RF transceiver. Wireless communication within the HAN 100 may be configured in accordance with a known wireless communication standard adaptable for use in the HAN environment. Those skilled in the art will appreciate that a most suitable wireless communication standard is one that provides reliable data delivery among the devices of the HAN 100 with low latency and at comparatively low cost. Because of the nature of communication among the devices of the HAN 100, and the need to maintain transceiver modules in all devices in the HAN 100, implementation of a standard requiring relatively low transmission power, which will prolong battery life in devices on the HAN 100.

In particular, the HAN and the devices therein may be implemented with radio modules and host processors adapted to operate in compliance with the ZigBee® 1.0 or later specification, based on or incorporating portions of the IEEE 802.15.4-2003 wireless communication standard (“Standard for Information Technology Telecommunications and Information Exchange between Systems—Local and Metropolitan Area Networks—Specific Requirements Part 15.4: Wireless Medium Access Control (MAC) and Physical Layer (PHY) Specifications for Low Rate Wireless Personal Area Networks (WPANs)”. New York: IEEE Press, 2003). A ZigBee network typically employs a mesh topology; thus, devices 120 through 166a . . . n may communicate with the ESP 110 directly, or else with the ESP 110 through neighbouring devices via the shortest or a preferred communication path. The arrows in FIG. 1 illustrate possible communication paths within a HAN 100 implementing the ZigBee specification. The ZigBee specification may optionally be implemented in accordance with one or more of application profiles developed for use with the ZigBee specification, such as the Smart Energy Profile Specification, Revision 15, 2008 or the Home Automation Profile Specification. These profiles define messages, message formats and processing actions relevant to management of energy-consuming devices and automation of electrical devices within the home, respectively, to provide for interoperability among ZigBee-compatible devices. The ZigBee specification and the Smart Energy and Home Automation Profiles are published by the Zigbee Alliance, and are available from http://www.zigbee.org. The foregoing references are incorporated herein by reference. Of course, other standards, specifications and profiles may be employed.

A block diagram of select components of the various devices 120 through 166a . . . n is provided in FIG. 2. A typical device 200 may be provided with a host processor 210, which may be configured to control the functions of the device 200. The host processor 210 may send data to and receive data from an RF transceiver 260, and thereby communicate with the HAN 100. The RF transceiver may be provided in a module 250. Communication between the module 250 and the host processor 210 may be provided through any suitable interface 290, such as a universal asynchronous receiver/transmitter, and implementing any suitable protocol, such as a protocol for serial communication. If ZigBee-compatible devices are deployed in the HAN 100, the devices may be provided with ZigBee-compatible modules comprising integrated radios and microcontrollers with on-chip memory, such as the EM250 or EM 350 series ZigBee® system-on-chip, manufactured by Ember Corporation, Boston Mass. 02210, or the CC2430 Zigbee®/IEEE 80.215.4™ system-on-chip manufactured by Texas Instruments Incorporated, Dallas Tex. 75243.

In addition to the transceiver 260, the module 250 may also comprise memory 270 and optionally secure memory 320, and a processor 280. The memory 270 may include memory for storing applications 300, an event data cache 272, and a network configuration data cache 274. In some embodiments, the processor 280, the memory 270, and the transceiver 250 may all be comprised in a single integrated package such as the aforementioned system-on-chip. In these embodiments, the memory 270 may comprise flash memory, a portion of which is devoted to storage of application code and storage of both volatile and non-volatile data, and the remainder of which may be used for manufacturing-related data, such as the MAC address of the module 250, and other data that may be stored in memory during the manufacturing process, such as security certificates. In these embodiments, there may be no separate secure memory 320.

The data store in the network configuration data cache 274 may include at least a current network time and an identifier for a current network or the most recent previous network to which the module 250 had been joined. In addition, the network configuration data cache 274 may include security and device identifier options, such as preconfigured link keys, encryption protocols, and in the case of a device 200 configured to be used in accordance with a predetermined profile, such as the Smart Energy Profile specification, a profile description device identifier, and identifiers for supported server and client clusters that are supported by the device 200. The clusters identify the groups of services that the module 250 is configured to support. The network configuration data may also include custom profile identifiers for the device 200. Security options may include identification of the types of encryption and authentication supported by the processor 280, such as elliptical curve cryptography, APS encryption, and processes for generating link keys. The data in the foregoing network configuration data cache 274 may be modified by the host processor 210, and are generally set prior to the module 250 attempting to scan for and join a network. Default settings for the data in the network configuration data cache 274, such as default settings for link keys, supported server and client clusters, profile description device IDs, security options, and other custom profile IDs may also be stored in the memory 270. The event data cache 272 may include data received from the ESP 110 during the course of normal network operation for controlling the device 100. The types of event data stored in the cache 272 may be determined by a profile or other specification, such as the Smart Energy Profile. In this embodiment, the event data cache 272 comprises messages 275, price data 276, demand response and load control data 277, and may include other scheduled event data 278. Depending on the configuration of the module 250 and the memory 270, the event data cache 272 may be stored in volatile memory rather than in non-volatile memory.

The processor 280 may be configured to perform cryptographic operations in accordance with any suitable public or shared secret key cryptographic protocol. As will be appreciated by those skilled in the art, public-key cryptography protocols are widely implemented, and each individual module 250 and ESP 110 may be provided with one or more private keys 330 and corresponding public keys 332 for use in encrypted and/or authenticated communications. If the module 250 includes secure memory 320, then the private keys 330 may be stored in the secure memory; otherwise, they may be stored elsewhere in the memory 270. The private keys 330 may be used for digitally signing messages for authentication purposes, or other authentication or cryptography-related functions. As noted above, the private keys 330 may be provisioned during the manufacturing stage, although they may be added to the memory at a subsequent stage, for example during a flash update to the memory 270. The module 250 may also be provisioned with a corresponding root key from the Certificate Authority providing the device's public and private keys 332, 330 for use in verifying the digital certificates comprising the module 250's public keys 332. The modules 250 and ESP 110 may also exchange corresponding public keys, as described below, so that messages exchanged by the modules 250 and ESP 110 may be encrypted. Public keys received from other devices on the network may be stored in the non-secure memory area of the memory 270.

As can be seen from FIG. 2, the device 200 may communicate wirelessly with the ESP 110. FIG. 2 also illustrates the basic architecture of the ESP 110, which comprises a transceiver 340 in communication with a processor 350 and a memory 360. Optionally there may be a secure memory area 370 for storage of private keys 372, while non-secure memory 360 may be used for storing other data, and for example may include memory for storing applications 362, a network configuration data cache 364, public key storage 373, and an event data cache 365. As with the device 200, the types of event data stored in the cache 365 may be determined by a profile or other specification implemented in the HAN 100. In this embodiment, the event data cache 365 may comprise messages 366, price data 367, demand response and load control data 368, and other scheduled event data 369. However, since the ESP 110 serves a function as a gateway or server for the other devices 200 on the HAN 100, the event data stored by the ESP 100 may include data pertinent to multiple devices 200. Further, since the ESP 110 may also operate as a network coordinator, and the network configuration data cache 364 may store other types of data not typically stored by the other devices 200, such as a binding table for associating the various modules 250 within each device 200 with services provided by the ESP 110.

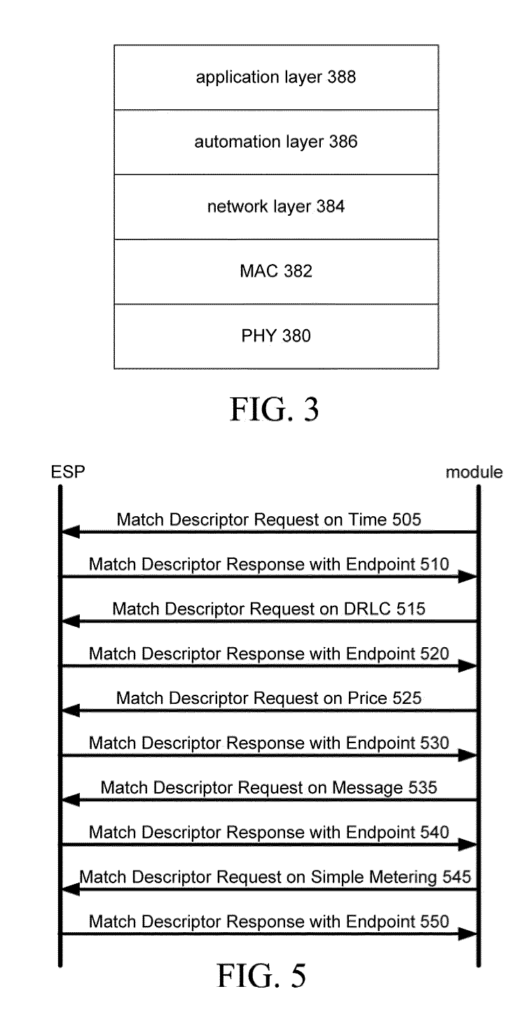

As described above, the module 250 may be configured to use the ZigBee protocol for network communications. An example of the architecture that may be used in the module 250 is illustrated in FIG. 3. The physical layer and the medium access control layers 380, 382 may be defined in accordance with IEEE 802.15.4, controlling signal transmission over the radio channel and access to the radio channel, respectively. Overlaying the medium access control layer are a network layer 384, which manages the processes of joining and leaving networks, network discovery, name binding, routing and security, and an application layer 388, which manages service discovery and binding, forwarding of messages between network devices, and defining coordinator and end device roles for the devices within the network. The functions of the networking layer 384 and the application layer 388 are defined by the ZigBee protocol. As will be understood by those skilled in the art, however, development of applications for the ZigBee protocol may consume an inordinate amount of resources that manufacturers of consumer devices 200 may be unwilling to commit; development of applications for the ZigBee protocol stack requires understanding of the network layer. Furthermore, the host processor 210 on each device 200 must be configured to interface with the protocol stack, and to handle all requests and responses for other devices on the same network. This potentially requires a high level of customization of the host processor 210 and/or the application 300 that the manufacturer may be unwilling to implement, particularly for devices already in production. For example, having the host processor 210 of a device 200 instruct the module 250 to scan for and join a network requires multiple instructions and acknowledgements to be transmitted between the host processor 210 and the module 250 to instruct the application 300 to not only scan for and join the network, but also to embark on key exchange with a server device, issue requests for service endpoints to discover available services and then request binding to those services, and so forth. Each of these processes may involve multiple steps and interactions between the application 300 and the networking layer 384. Accordingly, the embodiment of FIG. 3 also includes an automation layer 386, which operates between the application layer 388 and the networking layer 384 to provide the application 300, executing at the application layer 388, with a simpler interface to the networking layer 384 and thus to the network. The application 300 may therefore receive simple instructions from the host processor 210 to carry out sophisticated tasks, such as service discovery and binding, which in turn are provided to the automation layer 386. The automation layer 385 may then translate these simple instructions received via the application 300 to a series of finer-grained instructions transmitted to through the networking layer 384.

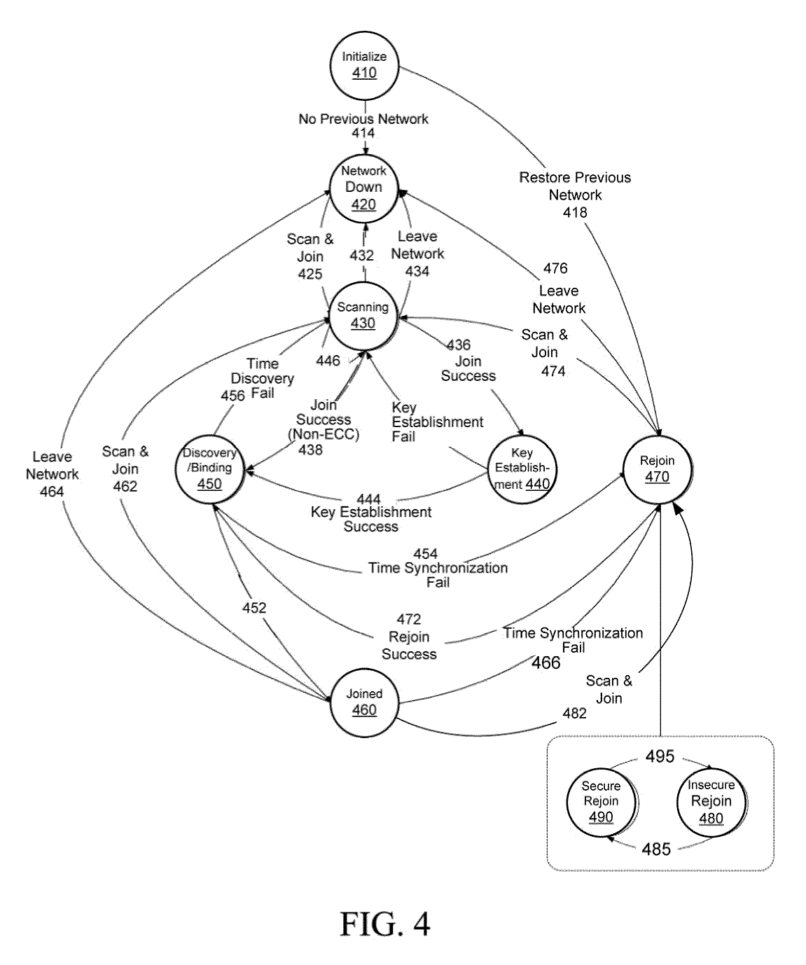

The process of network joining in the HAN 100 will now be described with reference to FIGS. 4 to 7. The process for a device 200 to join the HAN 100 is illustrated in the state diagram 400 depicted in FIG. 4. When a module 250 comprised in a device 200 is initially introduced to the HAN 100, it may be placed in an initialization state 410 by its host processor 210. The initialization state 410 may be triggered by a reset command received from the host processor 210, for example as part of a boot up process. The module 250, not having previously formed part of a network 414, then enters a network down (i.e., not joined) state 420 and remains in that state until it transitions to a scanning state 430. The module 250 may be configured to automatically enter the scanning state 430 upon initialization, or alternatively it may wait until prompted by the host processor 210 via a scan and join network command 425. A scan and join network command 425 may comprise a network identifier directly identifying the network to scan for; for example, in the ZigBee protocol, a PAN ID and/or an extended PAN ID may be provided, and the ESP 100 or another device that is already joined to the network may broadcast the PAN ID or extended PAN ID. The command 425 may also or instead comprise a channel mask, identifying a range of channels over which the module 250 may scan for an appropriate network 100 to join. If the module 250 fails to locate a channel 432, it will return to the network down state 420 and remain in that state until a new command is received to scan and join a network 425. Whenever the module 250 changes its state, a notification may be sent to the host processor 210 to advise of its network status change in a network status response. The host processor 210 may also request the module 250's network status in a network status request. In addition to the initialization state 410 and the network down state 420, it can be seen from FIG. 4 that other states of the module 250 may include scanning 430, service discovery and binding 450, key establishment 440, joined 460, and secure and unsecure rejoin 480, 490.

If the module 250 successfully locates and joins a network at 438, it may automatically enter a service discovery and binding state 450 in which it attempts to discover services provided by the ESP 110 on the network 100. The communications between the module 250 and the ESP 110 are illustrated in FIG. 5. The communications may comprise a series of requests for descriptors of the services available from the ESP 110, and the ESP 110's responses to the requests. If the module 250 is configured to implement a specific profile based on the ZigBee specification, such as the Smart Energy Profile, the module 250 may request descriptors of the clusters (i.e., attributes of the groups of functions) defined in the profile that are available at the ESP 110. If the ZigBee Smart Energy Profile is implemented, the module 250 may request descriptors 505 and receive responses 510 for the Time cluster; Demand Response and Load Control cluster (request 515, response 520); Price cluster (request 525, response 530); Message cluster (request 535, response 540); and Simple Metering (request 545, 550). The responses from the ESP 110 will indicate whether these services are available to the module 250, and will identify the addresses or endpoints for each of these services. The identified endpoints received in response by the module 250 may be stored in the memory 270 for use in addressing messages to those particular service endpoints during subsequent communications. The requests need not be presented by the module 250 in the order indicated in FIG. 5. If one or more of the services requested by the module 250 is not available, the ESP 110 may return an error in response to the request. However, such an error may be considered transient and the module 250 need not return to the network down state 420 or reattempt to locate and join a network. Instead, the module 250 may proceed to request descriptors for other clusters from the ESP 110, or alternatively may proceed to complete binding to the clusters that are available on the ESP 110.

During the process of service discovery, timeouts may be experienced while the module 250 awaits a response to a request from the ESP 110. If a timeout 456 occurs during service discovery, the module 250 may presume that it has lost connectivity with the network and may return to the scanning state 430, at which point it may resume scanning for a network as described above. Such a timeout error may be considered to be a terminal error, resulting in the module 250 transitioning to a different state to handle the error.

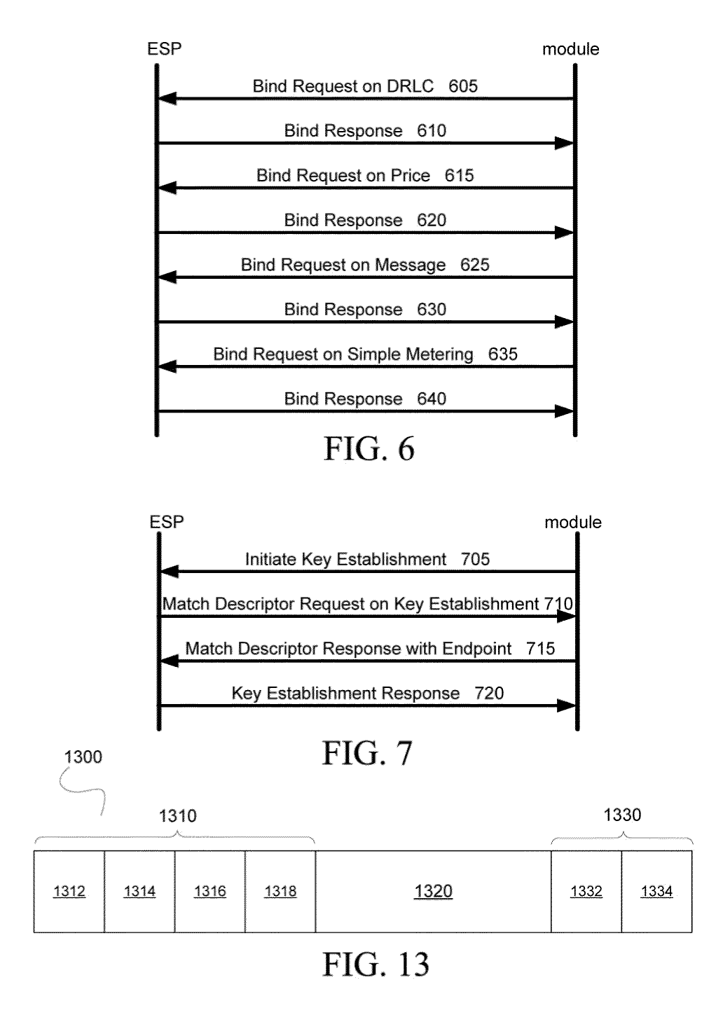

If one or more services are successfully discovered during service discovery, the module 250 may then transmit binding requests to bind the module's 250's own Time, Demand Response and Load Control, Price, Message and/or Simple Metering clusters with the corresponding clusters at the ESP 110. Binding information linking each cluster at the module 250 (including endpoints for addressing of messages to the module 250) to the clusters at the ESP 110 is stored in a binding table at the ESP 110. As shown in FIG. 6, the binding process may comprise a number of requests transmitted by the module 250 to the ESP 110, and responses confirming binding (or a failure) transmitted from the ESP 110 to the module 250. For example, the binding process may comprise a request for demand response services 605, and a corresponding response 610, as well as corresponding requests and responses for price services (request 615, response 620), message services (request 625, response 630), and simple metering (request 635, response 640). Once binding of services to the module 250 is complete, the module 250 may then attempt to synchronize its event data cache 272 with the most recent data held by the ESP 110 by transmitting requests for both current and forthcoming scheduled event data 278, price data 276, and most recent messages 275. If, during the synchronization process, communication between the ESP 110 and the module 250 times out 454, the module 250 may then enter a rejoin state 470, discussed below. Otherwise, if synchronization is successful, then the service discovery and binding process is successful 452, and the module 250 transitions to a joined state 460.

The module 250 and the ESP 110 may be adapted to communicate securely. Therefore, the network joining process will include a key establishment process. Once the module 250 has successfully located a network to join 436, it enters a key establishment state 440 during which the ESP 110 and the module 250 negotiate encryption or authentication protocol information. Turning to FIG. 7, the key establishment process may be initiated by the ESP 110 at 705 upon detection of the device 200 on the network 100. The module 250 then responds with a request 710 for an identification of the key-based services provided by the ESP 110, to which the ESP 110 responds 715 with an identification of the encryption and/or authentication protocols supported by the ESP 110. The module 250 may then transmit a key establishment response 720, identifying the protocol or protocols to be used in communications between the module 250 and the ESP 110, based on the security options stored in its memory 270. The response may further include a copy of the module's public key certificate comprising its public key 304. Any errors 442 encountered during the key establishment process may be considered terminal errors, causing the module 250 to return the scanning state 430, where it will again attempt to locate and join a network. Errors may occur, for example, if the response from the ESP 110 to the request 710 for identification of key-based services indicates that none are provided, if key exchange is not completed within a predefined period of time, or if it is determined that the module 250 lacks a valid certificate. Upon successful completion of the key establishment process 444, the module 250 may enter the service discovery and binding state 450 described above.

Once in the joined state 460, the module 250 may, in response to an explicit command from the host processor 210, transition from the joined state 460 by leaving the network. The module 250 may then, in response to a further command, attempt to join a new network or the previously joined network. The module 250 may alternatively attempt to rejoin a network, for example in the case where the host processor 210 determines that there has been a loss of communication with a currently joined network. For example, a leave network command may be received 464 from the host processor 210. The module 250 will then leave its current network 100 and not attempt to scan for any networks, and return to the network down state 420. The module 250 may only leave the network down state if it receives a command 425 to enter the scanning state 430, described above. If the module 250 receives a command from the host processor 210 to leave the network, then network configuration data stored in the configuration data cache 274 may then be deleted from the memory 270.

If the module 250, while currently in the joined state 460, receives a scan and join command 462 from its host processor 210, the module 250 may leave the network 100 (and may again delete the network configuration data from the cache 274), then enter the scanning state 450 to scan for a new (or the same) network to join. The scan and join command 462 may comprise a PAN ID or Extended PAN ID and channel mask value, thus directing the module 250 to enter the scanning state 430 and scan for and locate a network on a particular channel or a channel matching the mask. If the network identified in the scan and join command 462 is a different network 100 than the network to which the module 250 is currently joined, the module 250 will leave the current network and enter the scanning state 430, proceeding with optional key establishment and service discovery and binding as described above. If the scan and join command identifies the same network as the one to which the module 250 is currently joined, the scan and join command is effectively operates as a rejoin command 482, and does not delete any of the current network configuration data from the network configuration data cache 274; the module then enters the rejoin state 470, and re-scans for the same network it had previously been joined to based on the currently stored network configuration data, attempting to match its PAN ID and Extended PAN ID to any networks located.

The module 250 may also enter the rejoin state 470 in response to a power-up or a detected connection disruption. For example, the module 250 may be configured to periodically poll the ESP 110 while in the joined state to verify the state of its connection to the network, and to expect a response within a predefined period of time. If this heartbeat response is not received within the predetermined time frame, the module 250 may send an error message to the host processor 210, and transition to the rejoin state to attempt to repair the connection. Loss of the heartbeat signal is therefore considered a terminal error. As another example, if the module 250 may transition to the rejoin state if it experiences a timeout during an attempted synchronization of data between the ESP 120 and the module 250.

The rejoin state 470 may in fact comprise both an unsecure rejoin state 480 and a secure rejoin state 490. Upon entering the rejoin state, the module 250 may first attempt a secure rejoin 490, in accordance with the security options previously set in the module 250's memory 270. If the secure rejoin attempt fails 495, then the module 250 may transition to the unsecure rejoin state 480 and attempt an unsecure rejoin. If the unsecure rejoin attempt fails 485, then the module 250 may transition again to the secure rejoin state, and repeat the cycle of attempts a predetermined number of times until either the module 250 successfully rejoins its previous network; the host processor 210 instructs the module 250 to leave the network 476, and thus transition to the network down state 420; or the host processor 210 sends the module 250 a scan and join networks command 474, prompting the module 250 to transition to the scanning state 430, and to scan for a new network to join. In repeating the cycle of attempts to join the network either securely or unsecurely, the module 250 may be configured to pause after a predetermined number of attempts before repeating the cycle. For example, the module 250 may make four consecutive attempts to join (a set of secure-unsecure-secure-unsecure attempts), and if still unsuccessful, the module 250 will then “rest” for a predetermined number of times, e.g. 60 seconds, before making a further attempt. The pause or rest is included in the event that changes to the network environment in the meantime may have affected the module 250's ability to communicate with other devices on the network.

Initialization of the module 250 in a device 200 may be triggered by a reset command issued by the host processor 210. Network configuration data 274 may also be deleted from the memory 270, although the module 250 may retain the network configuration data pertaining to the currently joined or last joined network. After deletion of scheduled event data from the event data cache 272, the module 250 may query the network configuration data to determine whether the module 250 had previously been joined to a network. If the module 250 was joined to a network at the time of receipt of the reset command, the module 250 may attempt to rejoin the same network as indicated by 418 in FIG. 4, using the stored configuration data (e.g., a stored channel mask and PAN ID). If the module 250 was not joined to a network at the time the reset command was received, then after reset the module 250 will remain in the network down state 420 until a command to scan for and join a network is received from the host processor 210.

The host processor 210 may instruct the module 250 to carry out other maintenance functions. For example, the host processor 210 may instruct the module 250 to receive a firmware image, which may then be stored in the module's electronically programmable memory 270 and executed. The host 210 may also instruct the module 250 to restore certain default network or device data from default values stored in the memory 270, such as link keys, supported server and client clusters, profile description device IDs, security options, and other custom profile IDs. A command from the host processor 210 to restore default values will also cause the module 250 to reset and to leave its currently joined network, entering the network down state 420.

The foregoing network formation and joining process may be implemented in the context of a HAN 100 for the operation of smart energy devices, and implementing a profile such as the ZigBee Smart Energy Profile. However, it will be appreciated by those skilled in the art that the foregoing processes may be equally applicable to other types of networks, in particular ZigBee-based networks, and to devices and servers providing different types of services other than energy management-related services.

In the specific example of a ZigBee-based HAN 100 implementing the Smart Energy Profile, the device 200, through its module 250 and the host processor 210, may participate in the HAN 100 once joined to that network, sending and receiving messages to and from the home energy management console 150 and to and from other devices on the HAN 100, including the ESP 110. The Smart Energy Profile is presently defined with four functional clusters, or groups of service attributes directed to Demand Response and Load Control; Price; Messaging; and Simple Metering. The profile includes other profiles, such as a Key Establishment and Time clusters. As explained above, during the service discovery and binding stage the device 200, through its module 250, may be bound to the clusters provisioned at the ESP 110, and the module 250's event data store 272 may be synchronized with the data stored at the ESP 110. Once bound, the host processor 210 may initiate and respond to events supported by each of these clusters. In some embodiments, certain events may be handled automatically by the module 250, without requiring intervention or response from the host processor 210. Responses by the host processor 210 to the module 250 to certain scheduled events may be triggered by a user command.

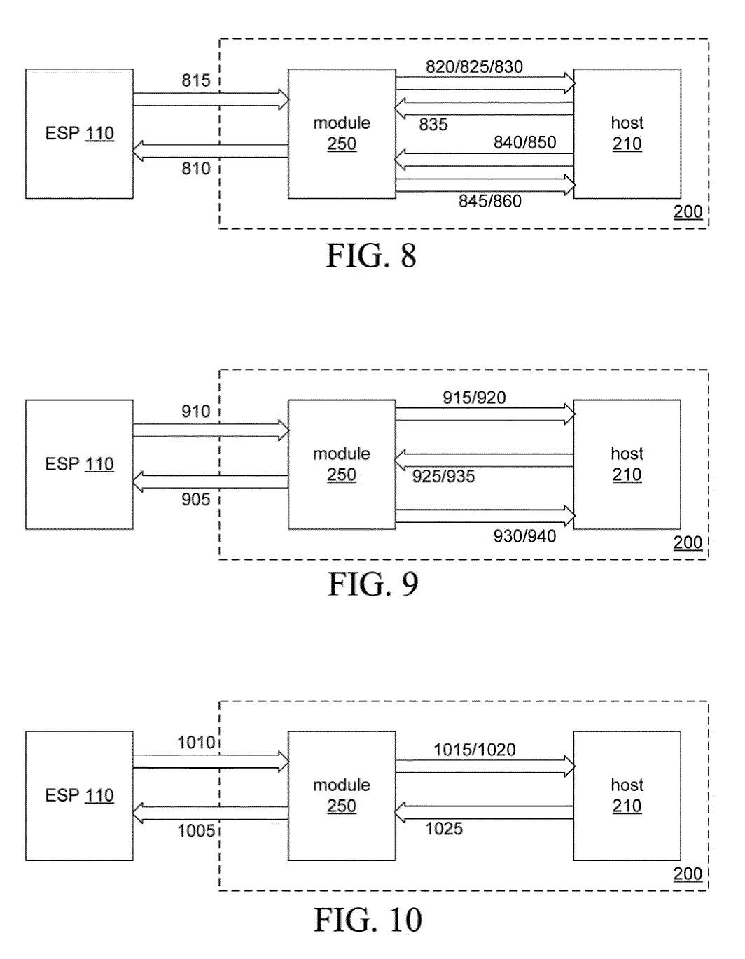

The device 200 may be a client of Demand Response and Load Control cluster, adapted to receive events from the ESP 110. As shown in FIG. 8, upon synchronizing with the ESP 110, the module 250 may transmit a get scheduled events command 810. The command may include a limit value, identifying the number of events to be retrieved from the ESP 110. In response, the ESP 110 may transmit any scheduled events 815 identified for that module 250. The limit on the number of scheduled events to be transmitted to the module 250 may be predefined; for example, the ESP 110 may transmit only the three most recent events to the module 250, as the module 250 may be configured to store only a limited number of events in its memory 270. The number of events may be determined based on available memory 270 for storing scheduled events instead. The most recent events are typically those with a scheduled start time closest to the present time, although events defined in the Demand Response and Load Control cluster may be associated with future time periods. Therefore, received scheduled events are cached by the module 250 until the time of execution, at which point the module 250 relays that event to the host processor 210 as a demand response event start message 820. When the event is complete, or the duration associated with the event expires, it may be cancelled, and the module 250 may transmit a demand response event stop message 825, and delete the event from its memory 270. The host processor 210 may respond to an event start message 820 with an opt in or opt out message 835, indicating whether the host processor 210 will comply with the event indicated in the event start message 820 or not. For example, a utility may push to the HAN 100 a request for devices on the network to reduce energy consumption during a specified period of time. This request may be transmitted to the module 250 from the ESP 110 in the form of a scheduled event message, which in turn is transmitted to the host processor 210. The host processor 210 may then cause a message to be displayed at a user interface in communication with the processor 210, requesting user confirmation that the device is to participate in the request. If a response from the user indicating confirmation is received, the processor 210 may then respond with an opt in message 835. If the response received from the user indicates that the device is not to participate, then the message would then indicate that the device is opting out of the request. Similarly, informational messages may be pushed to devices in scheduled event messages, which may then be displayed to a user who is then requested to confirm, via a user interface on the device, that the message was received and/or read. This confirmation may be transmitted at 835 as well.

Events that are scheduled to take place in the future may also be relayed by the module 250 to the host processor 210, so that the host processor 210 may generate a schedule of upcoming events to manage the device 200. Future events may be provided to the host processor 210 in demand response received messages 830. Thus, the module 250 may handle all scheduling and caching of events on behalf of the host processor 210, and the host processor need only act on the event start or stop commands received from the module 250; the host processor 210 need not store all scheduled event data itself, as the module 250 is configured to transmit messages to the host processor 210 to alert the host processor 210 to the commencement and ending of scheduled events.

The host processor 210 may also query the module 250 for information pertaining to scheduled events stored at the module 250 for the purpose of scheduling. The host processor 210 may transmit a demand response count request 840 to obtain a reply 845 reporting the count of the number of scheduled events currently stored at the module 250, and may further transmit a demand response cached event request 850 to obtain cached events from the module 250. The demand response cached event request 850 may comprise a count value, which will be used to determine the number of scheduled events returned to the host processor 210 in the reply 855. If the number of events to be retrieved is less than the total number of scheduled events stored at the module 250, then the events retrieved in the reply 855 may comprise those events having their start time occurring before or soonest after the current time. Each event returned by the module 250 is reported in a separate reply 855.

FIG. 9 illustrates communications between the module 250, the host processor 210 and the ESP 110 in support of the price cluster.

FIG. 9 illustrates that the module 250 may transmit a get scheduled prices message 905 to the ESP 110. This may form part of the initial synchronization between the module 250 and the ESP 110. In response, the ESP 110 may reply 910 with published prices. The number of prices transmitted in response to the module 250 may be set at a predefined limit, which may be determined based on the amount of memory 270 available for storage of scheduled events. Price events may be associated with scheduled start times, so the module 250 may cache the price event in memory 270 until the designated time of execution. At the start time for the scheduled price event, the module 250 may transmit a price event start message 915 to the host processor 210. If the price event is associated with a duration (i.e., it has an end time), or if the price event is superseded by a newer, overlapping price event, then the module 250 transmits a price event stop message 920 to the host processor 210, and deletes the terminated or superseded price event from its memory 270.

Future price events stored in the module memory 270 may be transmitted to the host processor 210 in a price event received message. The host processor 210 may use this information to schedule future events, although as noted above the module 250 may handle all scheduling and caching of events on behalf of the processor 210. If the module 250 receives a price event that is scheduled to commence immediately, then the module 250 relays this information to the host processor 210 in a price event start message 915.

If the module's memory 270 is storing the maximum number of price events that may be cached at the module 250 and a new price event is received by the module 250 from the ESP 110, the module 250 may compare the start time of the new price event with the price events currently stored in memory 270. If the new price event has a start time preceding the start time of the latest-occurring price event currently in memory, then that latest-occurring price event is discarded, and the new price event stored in the memory 270. Otherwise, the newly received price event is discarded, as the cached price events stored in the memory 270 precede the newly received event.

Similarly to the demand response cluster messages, the host processor 210 may query the module 250 for information pertaining to price events stored at the module 250 for the purpose of scheduling. The host processor 210 may transmit a price event count request 925 to obtain a reply 930 reporting the count of the number of price events currently stored at the module 250, and may further transmit a price cached event request 935 to obtain cached price events from the module 250. The price cached event request 935 may comprise a count value, which will be used to determine the number of price events returned to the host processor 210 in the reply 940. If the number of events to be retrieved is less than the total number of price events stored at the module 250, then the events retrieved in the reply 940 may comprise those price events having their start time occurring before or soonest after the current time. Each price event returned by the module 250 is reported in a separate reply 940.

Messages may also be transmitted between the ESP 110, the module 250, and the host processor 210. The content of messages may be set arbitrarily. The size of a message, for example, may be limited to a predetermined number of characters or bytes. As with the price events and demand response scheduled events, the module 250 may be configured to store only a limited number of messages in its memory 270. When the device 200 joins the HAN 100, the module 250 may query the ESP 110 for any messages stored for that device 200 or device type. The query may consist of a get last message command 1005, as shown in FIG. 10. The ESP 110 may return a message 1010 if one is available. The message may be associated with a scheduled display time, in which case the module 250 may cache the message in its memory 270 until the scheduled time, at which point the module 250 may transmit a message display start message 1015 to the host processor 210. The message content is comprised in the message display start message 1015.

Once the message is completed (i.e. an end time associated with the message expires), is cancelled or superseded by another message, the module 250 may transmit a display message stop message 1020 to the host processor 210.

The system may be configured to request and transmit confirmation of receipt of the message. If a message confirmation flag is set in the message reply 1010 transmitted to the module 250 and thence to the host, the host processor 210, upon receipt and/or display of the message, may return a confirmation message 1025.

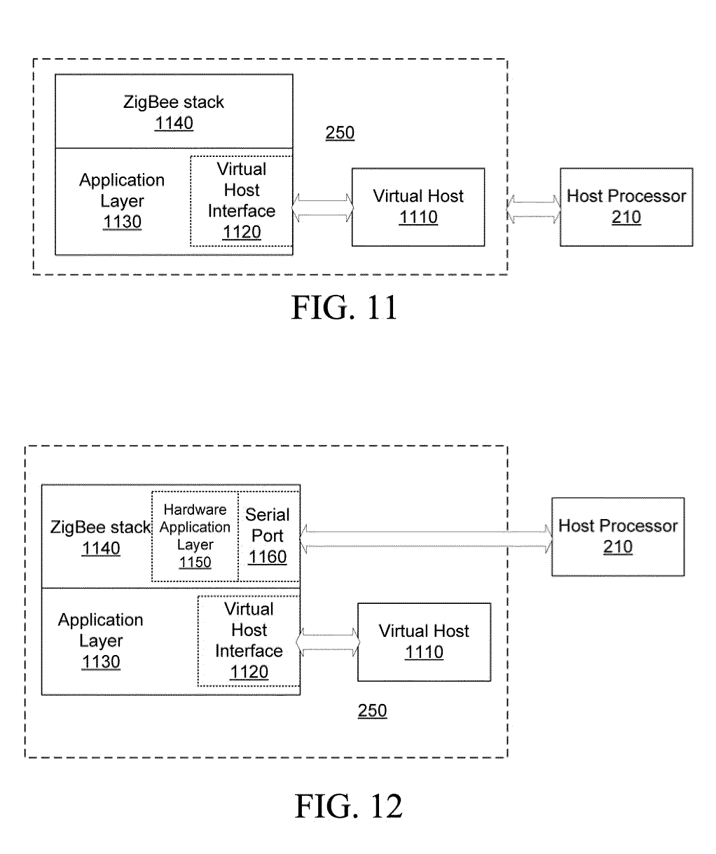

The foregoing examples were described in the context of a standard configuration illustrated in FIG. 2, in which the host processor 210 in the device 200 transmits commands to the module 250 using a predefined protocol, an example of which is described below. This protocol may be a communication protocol developed for use with the module 250, and in this standard configuration the device 210, and specifically the host processor 210, must be configured to adopt the protocol, and store a library of commands developed specifically for communicating with the module 250. The commands may be stored in on-chip memory in the host processor 210, or alternatively in other memory resident in the device 200. However, in some circumstances it may not be desirable to configure the host processor 210 and the device memory in this manner; for example, where devices 200 are retrofit to include the module 250, it may not be feasible to replace or reprogram the host processor 210 or device memory. Therefore, in a further embodiment, the module 250 may be provided with a virtual host application and interface for receiving host processor-specific or generic protocol communication. A schematic of this further embodiment is illustrated in FIG. 11.

The module 250 may be provided with a virtual host application 1110, which communicates with the host processor 210 over the host processor 210's custom protocol or using a general purpose I/O communications protocol. The virtual host application 1110 receives messages from the host processor 210 using the host processor's communications protocol, and translates the messages for use with the protocol employed by the application layer 1130 in the module 250. The virtual host application 1110 similarly receives messages from the application layer 1130, and translates the messages from the protocol employed by the application layer 1130 to the protocol used by the host processor 210.

Instead of a separate communications interface for between the module 250 and the host processor 210, the module 250 is provided with a virtual host interface application 1120 that receives messages from the virtual host application 1110 and communicates these messages to the application layer 1130.

A more detailed schematic of this embodiment is provided in FIG. 12. The virtual host interface 1120 is comprised in the application layer 1130, and is in communication with the virtual host 1110. The protocol stack 1140, generally illustrated in FIG. 3, includes a hardware application layer 1150 in communication with a serial port or other suitable interface 1160 for communicating with the host processor 210.

Communication between the module 250 and an external component, such as the host processor 210, may be carried out using a messaging protocol defining the format and content of frames or messages passed between the components. This protocol may thus define the content and format of messages transmitted between the module 250 and the processor 210 via the interface 290 shown in FIG. 2, or between the virtual host 1110 and the application layer 1130 of FIGS. 11 and 12.

An example of a format for a frame is shown in FIG. 13. Each frame may have a structure consisting of a header, a payload, and optionally a checksum. A header 1310 may comprise one or more fields 1312, 1314, 1316, 1318 discussed below. The payload 1320 may be a predefined size depending on the type of frame. For example, a module 250 transmitting a message may be permitted to transmit a frame with a payload size of 128 bytes, but may be restricted to receiving a frame with a 32 byte payload. Limitations on the size of a message or frame received by the module 250 may be determined with reference to the memory capacity of the module 250. In other embodiments, however, the length of the payload may not be so limited. A checksum 1330 may be provided, typically at the end of the payload 1320. In the example of FIG. 13, the checksum 1330 includes a least significant bit 1332 and a most significant bit 1334; as it is positioned at the end of the frame, the most significant bit 1334 may also function as an end-of-frame indicator. In other embodiments, a separate bit or other value may be appended to the frame 1300 to indicate the end of the frame. In one embodiment, the checksum is calculated by summing the values of bytes selected from the header 1310 and from the payload 1320. In the embodiment described below, the first field 1312 within the header is a start-of-frame indicator, and may be omitted from the checksum calculation. Thus, the checksum may be calculated using the remaining fields 1314, 1316, 1318, and the entire payload 1320. Any overflow above the size of the checksum 1310 provided in the frame may be discarded; thus, if the checksum 1330 is two bytes long, any overflow about two bytes is discarded. Alternatively, computation of the checksum may be carried out in accordance with any suitable method known to those skilled in the art.

The header 1310 may comprise a first start-of-frame indicator 1312, which may comprise an arbitrarily-set value, and a payload length indicator 1318, which comprises a value representing the length of the payload 1320. These fields 1312, 1318 may be defined to have a fixed byte size (e.g., one byte in length each). The remaining field or fields in the header 1310 comprise header information, used to define the frame type. In a simple embodiment, a single header field 1314 may be provided to define the frame type. In other embodiments, the header 1310 may comprise multiple fields (i.e., two or more). In the example of FIG. 13, two such fields 1314, 1316 are provided. Multiple fields may be defined in a hierarchical relationship, in which a first field 1314 comprises a parent or primary header, and a subsequent field 1316 comprises a secondary header.

In such an arrangement, the first field 1314 may define a general category or type of frame 1300, and the second field 1316 may define a subcategory or subtype first field value. For example, the primary header in the first field 1314 may simply identify the frame as a utility message (i.e., relating to conditions that are generally applicable to the module 250 or the ESP 110), a wireless network protocol message (e.g. relating to the implementation of the ZigBee protocol), a profile-related message or a cluster library-related message (e.g. relating to the ZigBee Smart Energy profile and associated clusters), or other general classes of messages relating to applications, security, or the like. Other general frame types may be defined by a user of the module 250.

Within each general type of frame 1300, a subcategory or subtype of frame may be defined for the secondary header field 1316. The subtypes are organized according to the general frame types described above. Thus, for utility messages, possible subtypes may include error, reset, or restore default subtypes; each of these subtypes (e.g. reporting an error condition, initiating a reset of the module 250 or ESP 110, or restoring default values from memory) are generally applicable to the operation of the module 250 or ESP 110 regardless of the current state of the component. Frame subtypes relating to the operation of the wireless network protocol may be defined according to network-related commands, such as scan and join, leave network, device discovery request/response, link key request/response, and so forth; in other words, the defined subtypes may reflect the various commands and steps described with respect of FIG. 4, above. Similarly, frame subtypes may be defined for the profile-related frame types in a manner reflecting the requests and responses transmitted between the ESP 110 and the module 250 during service discovery, binding, key establishment, and during regular messaging after service discovery and binding, as described above in relation to FIGS. 5 to 7 and FIGS. 8 to 10.

If the header 1310 includes additional header fields beyond the two shown in FIG. 13, these further header fields may be used to further define the particular frame type. Alternatively, the payload 1320 may comprise details concerning the condition or event indicated by the primary and/or secondary headers in the fields 1314, 1316. The content of the payload field 1320 may be defined by the communication protocol, and may in some embodiments include categories or further indicators or tertiary headers, below the secondary headers in the hierarchy, which serve to further define the event or condition reported in the frame 1300. For example, when an error is reported in a frame 1300, the primary header 1314 may indicate that the frame 1300 type is a utility message type, and the secondary header 1316 that the utility message is an error message. The payload 1320 may then identify the general type of error condition (e.g. a network error, a reset error, or a synchronization error), but also include a further error subtype—effectively a level of header below the secondary header level—identifying the particular type of error condition.

These error subtypes may be categorized according to the current state of the module 250 or ESP 110. Thus, a first class of error subtype may be associated with the module 250 or ESP 110 being in the scanning state 430, shown in FIG. 4: an error may be reported because no joinable networks were found while attempting to scan and join a network, for example, or a link key may be rejected. A second class of error subtype may be associated with the key establishment state 440, such as a failure to locate a certificate, timeout, and so forth. Similarly, additional classes of error subtype may be defined for the other states shown in FIG. 4, including the service discovery and binding state 450, the rejoined states 470 to 490 and the joined state 460. Other error subtypes may be defined in respect of specific actions carried out by the module 250 or ESP 110, such as a reset action, rather than by a current state of the component.

By providing the foregoing hierarchical frame type definitions, a robust description of the event or condition arising at the module 250 or ESP 110 may be provided in a single frame 1300, without relying on custom payload content.

The systems and methods disclosed herein are presented only by way of example and are not meant to limit the scope of the subject matter described herein. Other variations of the systems and methods described above will be apparent to those in the art and as such are considered to be within the scope of the subject matter described herein. For example, it should be understood that steps and the order of the steps in the processing described herein may be altered, modified and/or augmented and still achieve the desired outcome. It will also be appreciated that although the embodiments herein have been directed generally to smart energy devices, similar systems and methods may be carried out in respect of other types of devices.

The systems' and methods' data may be stored in one or more data stores. The data stores can be of many different types of storage devices and programming constructs, such as RAM, ROM, flash memory, programming data structures, programming variables, etc. It is noted that data structures describe formats for use in organizing and storing data in databases, programs, memory, or other computer-readable media for use by a computer program.

Code adapted to provide the systems and methods described above may be provided on many different types of computer-readable media including computer storage mechanisms (e.g., CD-ROM, diskette, RAM, flash memory, computer's hard drive, etc.) that contain instructions for use in execution by a processor to perform the methods' operations and implement the systems described herein.

The computer components, software modules, functions and data structures described herein may be connected directly or indirectly to each other in order to allow the flow of data needed for their operations. It is also noted that a module or processor includes but is not limited to a unit of code that performs a software operation, and can be implemented for example as a subroutine unit of code, or as a software function unit of code, or as an object (as in an object-oriented paradigm), or as an applet, or in a computer script language, or as another type of computer code.

1. A communications module for use in a consumer device, the communications module comprising:
a wireless transceiver adapted to communicate over a wireless link;
an interface for communicating with a host processor of the consumer device; and
a processor in communication with the memory, the wireless transceiver, and the interface, the processor being adapted to:
receive scheduled event data over the wireless link on behalf of the host processor;
schedule events for the host processor using the scheduled event data thus received; and
transmit commands for said scheduled events to the host processor for execution.

2. The communications module of claim 1, wherein the scheduled event data comprises at least one of:
Demand Response and Load Control events;
Price events; and
Messaging events.

3. The communications module of claim 1, wherein the wireless transceiver is adapted to communicate over a Zigbee wireless link, the processor is further adapted to implement a Smart Energy profile for use over said wireless link, and the scheduled event data comprises scheduled events defined in the Smart Energy profile.

4. The communications module of claim 1, wherein the processor is further adapted to receive the scheduled event data by synchronizing a data store in the communications module with data stored at a service portal over the wireless link.

5. The communications module of claim 1, wherein scheduling events for the host processor comprises caching the received schedule event data until an execution time associated with said received schedule event data, and generating a scheduled event message for the host processor for transmission to the host processor at the execution time.

6. The communications module of claim 1, wherein transmitting commands for said scheduled events to the host processor comprises:
generating at least one frame, the frame comprising a header and a payload, the header comprising a primary header field and a secondary header field, a primary header field value defining a first frame type and a secondary header field value defining a subtype of the first frame type, and the payload comprising data for said scheduled event; and
transmitting said at least one frame.

7. The communications module of claim 1, wherein the processor is further adapted to:
scan for and join the communications module to a wireless network;
upon joining the wireless network, bind to at least one service provided by a services portal on the wireless network,
wherein binding comprises identifying a service endpoint for said at least one service and transmitting binding information for the communications module to the services portal for storage at the services portal.

8. The communications module of claim 1, further comprising:
a virtual host module in communication with the interface and with the wireless transceiver,
wherein the communications module is configured to exchange the scheduled event data with the host processor over the interface according to a first protocol associated with the host processor and to exchange the scheduled event data over the wireless link according to a second protocol associated with an application layer of the communications module, and the virtual host module is configured to translate the scheduled event data between the first protocol and the second protocol.

9. The communications module of claim 8, wherein the communications module is configured to transmit said commands by:
generating at least one frame, the frame comprising a header and a payload, the header comprising a primary header field and a secondary header field, a primary header field value defining a first frame type and a secondary header field value defining a subtype of the first frame type, and the payload comprising data for said scheduled event; and
providing said at least one frame to the virtual host module for translation to a format associated with the second protocol.

10. A consumer device comprising:
a host processor; and
a communications module in communication with the host processor, the communications module comprising:
a wireless transceiver adapted to communicate over a wireless link;
an interface for communicating with a host processor of the consumer device; and
a processor in communication with the memory, the wireless transceiver, and the interface, the processor being adapted to:
receive scheduled event data over the wireless link on behalf of the host processor;
schedule events for the host processor using the scheduled event data thus received; and
transmit commands for said scheduled events to the host processor for execution.

11. A method for managing scheduled events for a consumer device, the method comprising:
receiving over a wireless link, at a communications module comprised in the consumer device, scheduled event data from a services portal;
scheduling events for a host processor of the consumer device using the scheduled event data; and
transmitting commands for said scheduled events to the host processor for execution.

12. The method of claim 11, wherein the scheduled event data comprises at least one of:
Demand Response and Load Control events;
Price events; and
Messaging events.

13. The method of claim 11, wherein receiving the scheduled event data comprises receiving said scheduled event data over a Zigbee wireless link and the scheduled event data comprises scheduled events defined in a Zigbee-compliant Smart Energy profile.

14. The method of claim 11, wherein receiving the scheduled event data comprises synchronizing a data store in the communications module with data stored at a service portal over the wireless link.

15. The method of claim 11, wherein scheduling events for the host processor comprises caching the received schedule event data until an execution time associated with said received schedule event data, and generating a scheduled event message for the host processor for transmission to the host processor at the execution time.

16. The method of claim 11, wherein transmitting commands for said scheduled events to the host processor comprises:
generating at least one frame, the frame comprising a header and a payload, the header comprising a primary header field and a secondary header field, a primary header field value defining a first frame type and a secondary header field value defining a subtype of the first frame type, and the payload comprising data for said scheduled event; and
transmitting said at least one frame.

17. The method of claim 11, further comprising, prior to receiving the scheduled event data from the services portal:
scanning for and join the communications module to a wireless network comprising the services portal;
upon joining the wireless network, binding to at least one service provided by the services portal,
wherein binding comprises identifying a service endpoint for said at least one service and transmitting binding information for the communications module to the services portal for storage at the services portal.

18. The method of claim 11, wherein scheduling events for the host processor comprises:
generating scheduled event commands for the host processor using the scheduled event data thus received, the scheduled event commands being generated in accordance with a first data protocol; and
translating the scheduled event commands thus generated into messages in accordance with a second data protocol using a virtual host module comprised in the communications module, the virtual host module being in communication with the host processor, the second data protocol being associated with the host processor;
and transmitting the commands for said scheduled events comprises transmitting the scheduled event commands thus translated to the host processor.

19. The method of claim 18, wherein generating scheduled event commands using the scheduled event data in accordance with the first data protocol comprises:
generating at least one frame, the frame comprising a header and a payload, the header comprising a primary header field and a secondary header field, a primary header field value defining a first frame type and a secondary header field value defining a subtype of the first frame type, and the payload comprising data for said scheduled event.

20. A computer program product comprising a non-transitory computer-readable medium storing code which, when executed by a processor of a communications module, causes the module to carry out the method of:
receiving over a wireless link, at the communications module, the communications module being comprised in a consumer device, scheduled event data from a services portal;
scheduling events for a host processor of the consumer device using the scheduled event data; and
transmitting commands for said scheduled events to the host processor for execution.
